(19) United States
(12) Patent Application Publication
(10) Pub. No.: US 2026/0251282 A1
(43) Pub. Date: Aug. 27, 2026

(54) SYSTEMS AND METHODS FOR ILLUMINATING A SURFACE

(71) Applicant: THE BOEING COMPANY, Arlington, VA (US)

(72) Inventor: Darren Carl McIntosh, Mukilteo, WA (US)

(73) Assignee: THE BOEING COMPANY, Arlington, VA (US)

(21) Appl. No.: 19/350,380

(22) Filed: Oct. 6, 2025

Related U.S. Application Data
(60) Provisional application No. 63/763,973, filed on Feb. 27, 2025.

(51) Int. Cl. F21V 3/04; B64D 11/00; B64D 11/02; F21V 7/04

(52) U.S. Cl. CPC F21V 3/049; B64D 11/02; B64D 47/02; F21V 7/04; F21V 33/004; G02B 6/0095; B64D 2011/0038

(57) ABSTRACT

A vehicle includes an internal cabin and a system for illuminating a surface. The system includes the surface within the internal cabin. The surface includes one or more translucent materials having one or both of a variable thickness, or one or more channels configured to receive one or more inserts. A lighting assembly is configured to illuminate the surface.

### CROSS-REFERENCE TO RELATED APPLICATION

This application relates to and claims priority benefits from U.S. Provisional Patent Application No. 63/763,973, filed Feb. 27, 2025, which is hereby incorporated by reference in its entirety.

### FIELD OF THE DISCLOSURE

Examples of the present disclosure generally relate to systems and methods for illuminating a surface, such as a countertop within a lavatory of a vehicle, and more particularly to systems and methods that control luminous intensity and provide lighting effects through a translucent material.

### BACKGROUND OF THE DISCLOSURE

Commercial aircraft are used to transport passengers between various locations. A typical commercial aircraft includes one or more lavatories within an internal cabin.

A lavatory within an internal cabin is illuminated by one or more lighting assemblies. Certain lavatories include lighting under a translucent countertop, which provides simple illumination, but without any effects.

U.S. Pat. Nos. 11,178,365, 11,563,924, and 11,902,715 disclose projection systems for translucent displays and methods of operation. U.S. Pat. Nos. 11,262,646, 11,720,011, and 12,105,407 disclose projection systems for baby-changing station translucent displays and methods of operation.

### SUMMARY OF THE DISCLOSURE

A need exists for a system and a method for providing illuminated effects in relation to a surface, such as of a countertop of a lavatory within an internal cabin of a vehicle.

With that need in mind, certain examples of the present disclosure provide a system configured for an internal cabin of a vehicle. The system includes a surface including one or more translucent materials having one or both of a variable thickness, or one or more channels configured to receive one or more inserts. A lighting assembly is configured to illuminate the surface. In at least one example, the surface is a countertop. As a further example, the countertop is within a lavatory.

In at least one example, the variable thickness includes a stepped portion. As a further example, the stepped portion includes a first section having a first thickness, a second section having a second thickness which is less than the first thickness, and a third section having a third thickness which is less than the first thickness and the second thickness.

In at least one example, the variable thickness includes a tapered portion. In at least one example, the variable thickness includes a stepped portion and a tapered portion.

In at least one example, the one or more translucent materials include multiple layers.

In at least one example, the surface includes the variable thickness and the one or more channels configured to receive the one or more inserts. As a further example, the variable thickness includes a stepped portion and a tapered portion.

In at least one example, the system includes a frame. A mirrored reflective dome is coupled to the frame. The lighting assembly is coupled to the frame. The lighting assembly is configured to emit light onto the mirrored reflective dome. The one or more inserts can include an interchangeable disk coupled to the frame. A hinge is coupled to the frame. The hinge is configured to pivot to allow the frame to open and close. In at least one example, the lighting assembly includes a plurality of light emitting diodes arranged in a circle and pointing inward.

Certain examples of the present disclosure provide a vehicle including an internal cabin; and a system including a surface including one or more translucent materials having one or both of a variable thickness, or one or more channels configured to receive one or more inserts, and a lighting assembly configured to illuminate the surface.

Certain examples of the present disclosure provide a method for an internal cabin of a vehicle. The method includes illuminating, by a lighting assembly, a surface of a countertop of a lavatory within the internal cabin. The surface includes one or more translucent materials having one or both of a variable thickness, or one or more channels configured to receive one or more inserts.

### BRIEF DESCRIPTION OF THE DRAWINGS

FIG. 1 illustrates a perspective front view of an aircraft, according to an example of the present disclosure.

FIG. 2 illustrates a perspective internal view of a lavatory, according to an example of the present disclosure.

FIG. 3 illustrates a block diagram of an aircraft, according to an example of the present disclosure.

FIG. 4 illustrates a simplified lateral view of a system, according to an example of the present disclosure.

FIG. 5 illustrates a simplified lateral view of a system, according to an example of the present disclosure.

FIG. 6 illustrates a simplified lateral view of a system, according to an example of the present disclosure.

FIG. 7 illustrates a top view of an insert, according to an example of the present disclosure.

FIG. 8 illustrates a perspective top view of a countertop within a lavatory, according to an example of the present disclosure.

FIG. 9 illustrates a block diagram of an aircraft, according to an example of the present disclosure.

FIG. 10 illustrates a simplified lateral view of a system, according to an example of the present disclosure.

FIG. 11 illustrates a simplified top view of an interchangeable graphic disk, according to an example of the present disclosure.

FIG. 12 illustrates a simplified lateral view of a system, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide controlled luminous intensity and lighting effects through a translucent material having a variable thickness. In at least one example, the systems and methods described herein include a structure, such as a countertop, having a variable thickness, which can be provided by a stepped change in thickness, and/or a tapered change in thickness. The variable thickness can be formed by machining and/or thermally forming the translucent material.

The stepped and/or tapered section(s), which can be formed through machining, allow visible surfaces to have contrast between lighter and darker lit surfaces. The thicker the material, the darker the resultant transmitted lighting. Conversely, the thinner the material, the brighter the resultant transmitted lighting.

Additionally, lighting effects of different colors and imaging can be achieved by bonding multiple layers of translucent materials. For example, a top countertop layer can be clear or otherwise plain, and a secondary layer under the top layer can include colored components. Single layer and/or multiple layers (inlaid, etc.) of translucent materials allow for branding and/or lighting effects.

Instead of permanently bonding multiple layers, an interchangeable graphic disc can be used to allow for quick changes (customization) of effects and images.

In an example, a lavatory within an internal cabin of a vehicle includes a cabinet (such as a lower cabinet below a sink). In at least one example, a system includes a hinged assembly providing a lighting assembly, such as including multiple light emitting diodes (LEDs), which can be arranged in a circle and pointing inward. The system can also include one or more interchangeable graphic disks of translucent material, and a mirrored reflective (inside) dome. In at least one example, the system provides a low profile assembly, which can be used in tight confines (such as a within a lavatory of a commercial aircraft), while protecting interior components from potential damage from within the lower cabinet.

Certain examples of the present disclosure provide a vehicle including an internal cabin, and a system including a surface within the internal cabin. The surface includes one or more translucent materials having one or both of a variable thickness, or one or more channels configured to receive one or more inserts. A lighting assembly is configured to illuminate the surface.

In at least one example, the surface is a countertop. The countertop can be within a lavatory.

In at least one example, the variable thickness includes a stepped portion. In at least one example, the variable thickness includes a tapered portion. The one or more translucent materials can include multiple layers.

In at least one example, the system includes a frame. A mirrored reflective dome is coupled to the frame. As a further example, the lighting assembly includes light emitting diodes coupled to the frame. An interchangeable disk is coupled to the frame. A hinge is coupled to the frame. The hinge is configured to pivot to allow the frame to open and close.

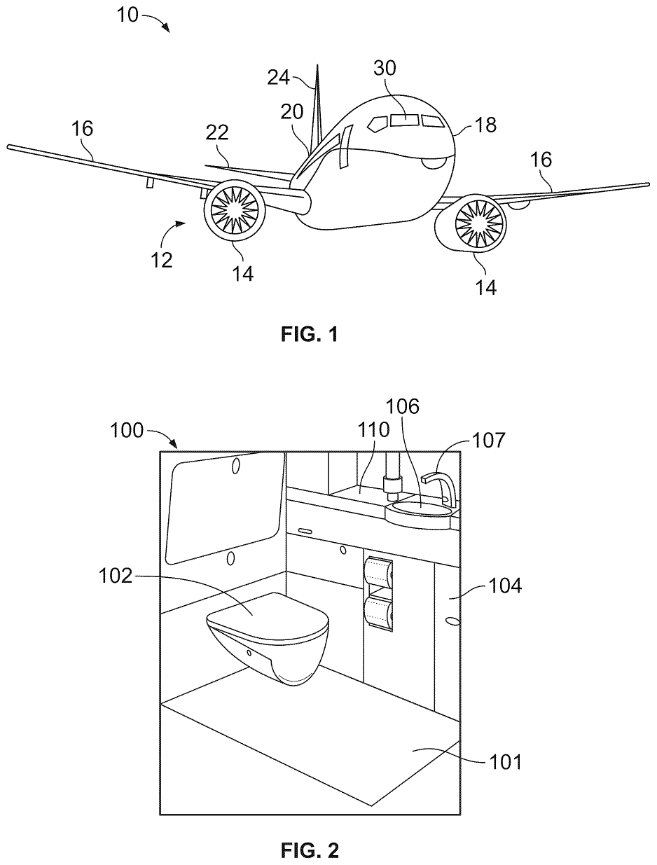

FIG. 1 illustrates a perspective front view of an aircraft 10, according to an example of the present disclosure. The aircraft 10 includes a propulsion system 12 that includes engines 14, for example. Optionally, the propulsion system 12 may include more engines 14 than shown. The engines 14 are carried by wings 16 of the aircraft 10. In other examples, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin 30, which includes a flight deck or cockpit, one or more work sections (for example, galleys, personnel carry-on baggage areas, and the like), one or more passenger sections (for example, first class, business class, and coach sections), one or more lavatories, and/or the like. Optionally, instead of an aircraft, examples of the present disclosure may be used with various other vehicles, such as automobiles, buses, locomotives and train cars, watercraft, and the like. Further, examples of the present disclosure may be used with respect to fixed structures, such as commercial and residential buildings.

FIG. 2 illustrates a perspective internal view of a lavatory 100, according to an example of the present disclosure. The lavatory 100 may be onboard an aircraft, such as the aircraft 10 shown in FIG. 1. Optionally, the lavatory 100 may be onboard various other vehicles. In other examples, the lavatory 100 may be within a fixed structure, such as a commercial or residential building. The lavatory 100 includes a base floor 101 that supports a toilet 102, cabinets 104, and a sink 106 or wash basin. A faucet 107 is configured to flow water into the sink 106. The faucet 107 is in fluid communication with a water supply, such as through one or more conduits, pipes, tubes, and/or the like. The sink 106 is disposed on and/or within a countertop 110, which is disposed on or otherwise over a cabinet 104. The lavatory 100 may be arranged differently than shown. The lavatory 100 may include more or less components than shown.

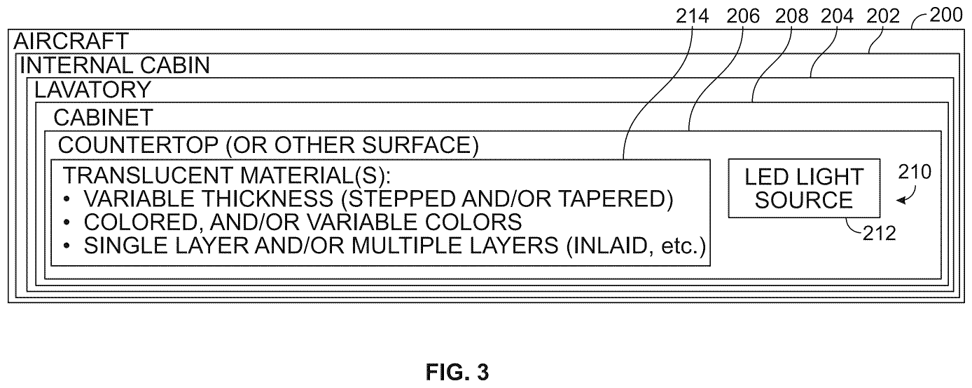

FIG. 3 illustrates a block diagram of an aircraft 200, according to an example of the present disclosure. The aircraft 10 shown in FIG. 1 is an example of the aircraft 200. The aircraft 200 includes an internal cabin 202. A lavatory 204 is disposed within the internal cabin 202. The lavatory 100 shown in FIG. 2 is an example of the lavatory 204.

The lavatory 204 includes a countertop 206, such as disposed on and/or over a cabinet 208, such as a lower cabinet. The countertop 206 is or otherwise includes a surface, which is configured to be illuminated. Optionally, the countertop 206 can be part of a structure other than a cabinet. For example, the countertop 206 can be a ledge within the lavatory 204. The countertop 110 shown in FIG. 2 is an example of the countertop 206. As another example, examples of the present example can be used within surfaces other than countertops, such as walls, floors, surfaces of structures (such as tables, desks, or the like).

A system 210 is configured to illuminate the surface, such as the countertop 206. The system 210 includes a lighting assembly 212, which includes a light source, such as one or more LEDs. The system 210 also includes a translucent material 214. The translucent material 214 can be or include a translucent plastic. For example, translucent material can be formed of an acrylic, such as polymethyl methacrylate, or a combination of acrylic polymer and alumina trihydrate (ATH).

In at least one example, the countertop 206 or other such surface is formed of the translucent material 214. In at least one example, the translucent material 214 has a variable thickness. For example, the translucent material 214 is machined to provide stepped or tapered portions. In at least one example, the translucent material 214 includes one or more colored portions, such as a single color, or variable colors. In at least one example, the translucent material includes a single layer, or multiple layers. In at least one example, the translucent material 214 has one or more of a variable thickness, one or more colored portions, a single layer, and/or multiple layers. The lighting assembly 212 is configured to emit light into and through the translucent material 214, thereby providing illumination thereof, and lighting effects therethrough and/or thereon, as described herein.

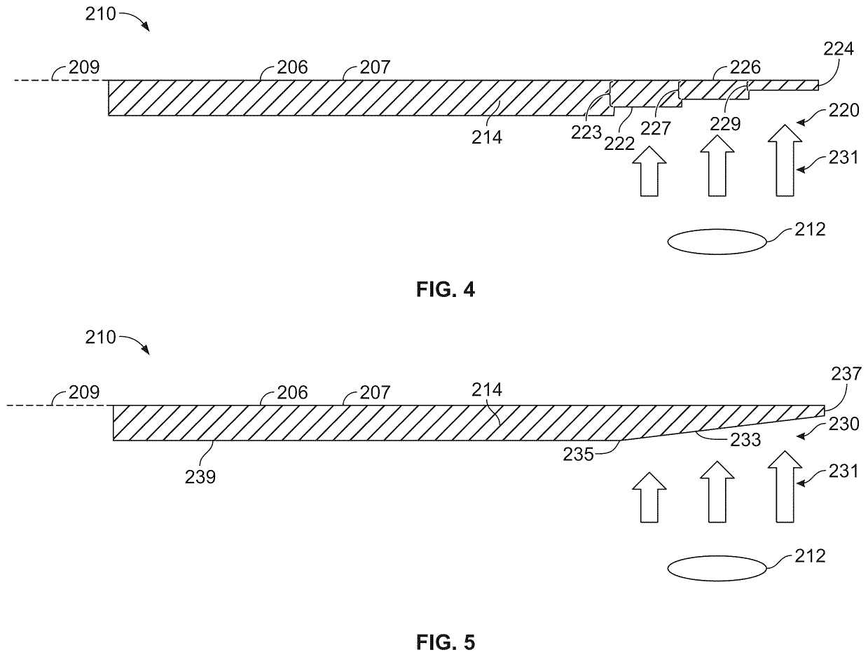

FIG. 4 illustrates a simplified lateral view of the system 210, according to an example of the present disclosure. As shown, the translucent material 214 can include a stepped portion 220, having a thick section 222 (for example, a first section), a thin section 224 (for example, a second or third section), and an intermediate section 226 (for example, a third or second section) therebetween. The thick section 222 has a first thickness 223. The intermediate section 226 has a second thickness 227, which differs from the first thickness 223. The thin section 224 has third thickness 229, which differs from the first thickness 223 and the second thickness 227. The first thickness 223 is greater than the second thickness 227, which is greater than the third thickness 229.

Light 231 emitted by the lighting assembly 212 passes through the translucent material, and provides an illuminated effect, in which the thick section 222 is darker than the thin section 224, for example. The increased thickness of the thick section 222 in relation to the intermediate section 226 and the thin section 224 dims the light 231 in contrast to the intermediate section 226 (and the thin section 224). Similarly, the increased thickness of the intermediate section 226 relative to the thin section 224 dims the light 231 in contrast to the thin section 224. Consequently, the thick section 222 appears darker than the intermediate section 226 and the thin section 224, and the intermediate section 226 appears darker than the thin section 224.

The countertop 206 has a top surface 207, which is flat, and is disposed within a plane 209. The stepped portion 220 is underneath the top surface 207. The stepped portion 220 can include more or fewer sections having different thicknesses. For example, the stepped portion 220 can include only the thick section 222 and the thin section 224 (but not the intermediate section 226). As another example, the stepped portion 220 can include four or more sections having different thicknesses. As an example, in addition to the thick section 222, the intermediate section 226, and the thin section 224, the stepped portion 220 can include one or more other sections having different thicknesses than those of the thick section 222, the intermediate section 226, and the thin section 224.

FIG. 5 illustrates a simplified lateral view of the system 210, according to an example of the present disclosure. In this example, the translucent material 214 includes a tapered portion 230, instead of a stepped portion. In at least one example, the translucent material can include the tapered portion 230, and the stepped portion 220 (shown in FIG. 4). The tapered portion 230 has a lower sloped surface 233 extending from a thick proximate end 235 (having an expanded thickness) to a thin distal edge 237 (having a reduced thickness as compared to the expanded thickness). The angle of the lower sloped surface 233 can be constant from the thick proximate end 235 to the thin distal edge 237. In at least one example, an entire lower surface 239 of the countertop 206 can be tapered. As another example, only a portion of the lower surface 239 can be tapered, as show in FIG. 5.

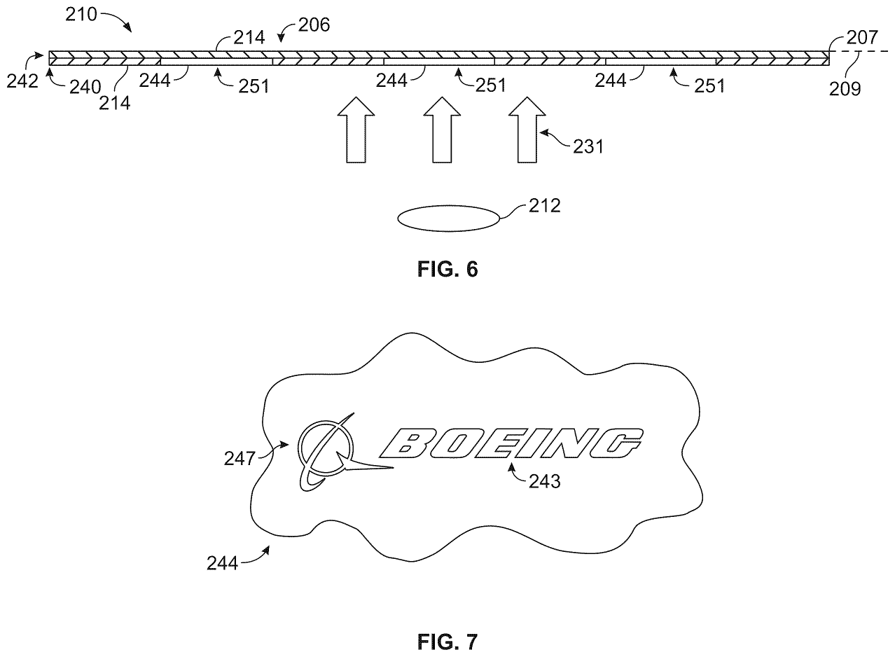

FIG. 6 illustrates a simplified lateral view of the system 210, according to an example of the present disclosure. In this example, a first layer 240 of the translucent material 214 is coupled to a second layer 242 of the translucent material 214. The first layer 240 can be below the second layer 242. The first layer 240 includes one or more inserts 244 (such as disks, panels, or the like), which can have different colors. The inserts 244 are retained within channels 251 of the first layer 240. The channels 251 are sized and shaped to retain the inserts 244. Optionally, the inserts 244 can be bonded to the second layer 242.

In at least one example, the system 210 can include two or more of the stepped portion 220 (shown in FIG. 4), the tapered portion 230 (shown in FIG. 5), and/or the multiple layers 240 and 242 (shown in FIG. 6). For example, the system 210 can include the stepped portion 220 and the multiple layers 240 and 242. As another example, the system 210 can include the tapered portion 230 and the multiple layers 240 and 242. As another example, the system 210 can include the stepped portion 220 and the tapered portion 230. As another example, the system 210 can include the stepped portion 220, the tapered portion 230, and the multiple layers 240 and 242.

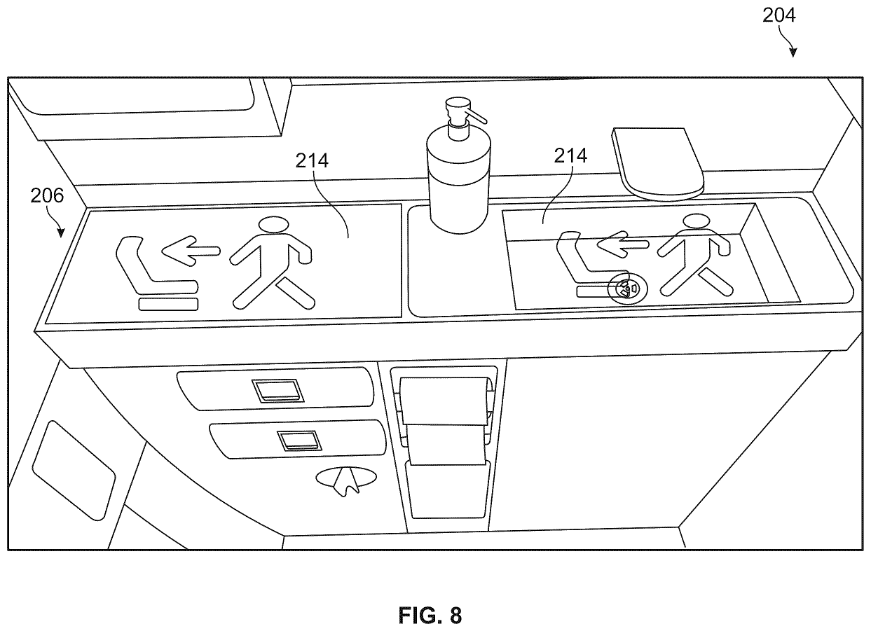

FIG. 7 illustrates a top view of an insert 244, according to an example of the present disclosure. The insert 244 can include different colors, graphics, text, and/or the like. For example, the insert 244 can include text 245 and/or a graphic 247, which can be in different colors.

FIG. 8 illustrates a perspective top view of a countertop 206 within a lavatory 204, according to an example of the present disclosure. The countertop 206 includes panels, such as can be formed of the translucent material 214. Illumination of the countertop 206 can be triggered by a light switch, engagement of a door lock, a flush of a toilet, an automated paper towel dispenser, use of the faucet, return to seat notification, and/or the like. The translucent material 214 can provide information through lighting effects. Such information can include a return to seat indication (as shown in FIG. 8), branding, advertisements, or the like.

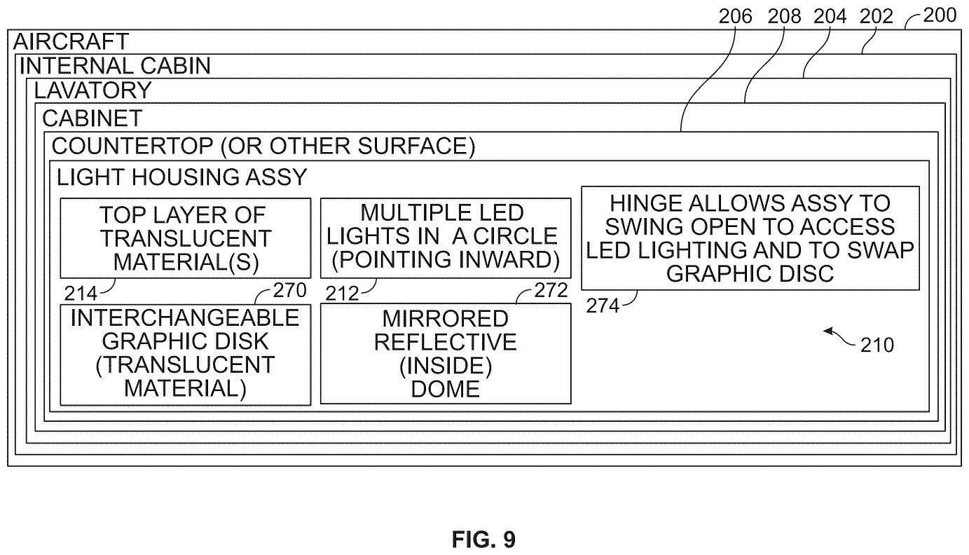

FIG. 9 illustrates a block diagram of an aircraft 200, according to an example of the present disclosure. In this example, the system 210 includes a lighting assembly 212 having LEDs arranged in a circle and pointing inward. The system 210 also includes an insert, such as an interchangeable disk 270 (such as can include one or more graphics), a mirrored reflective dome 272, and a hinge 274, which allows a frame holding the lighting assembly 212 and/or the mirrored reflective dome 272 to swing open to provide access to the lighting assembly 212 and the disk 270.

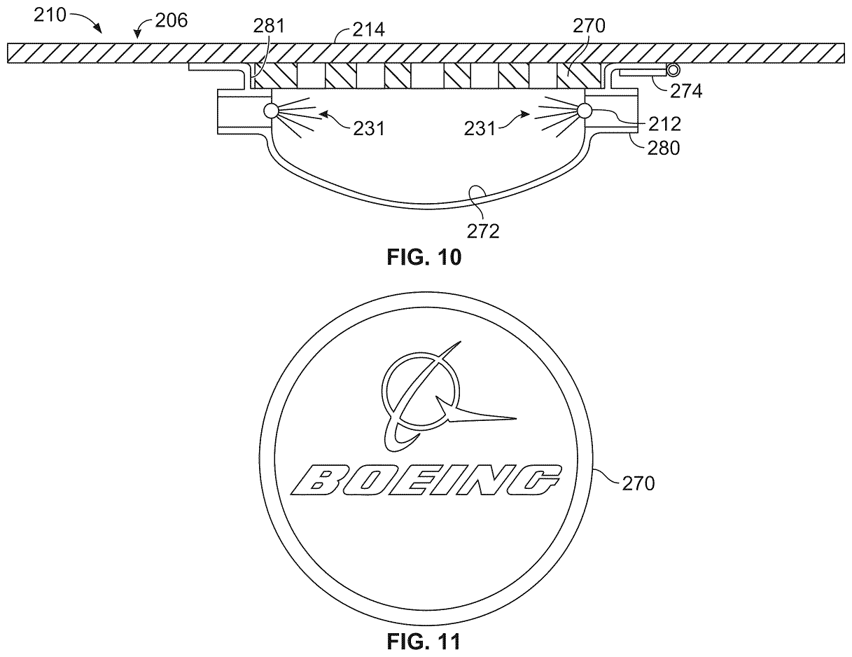

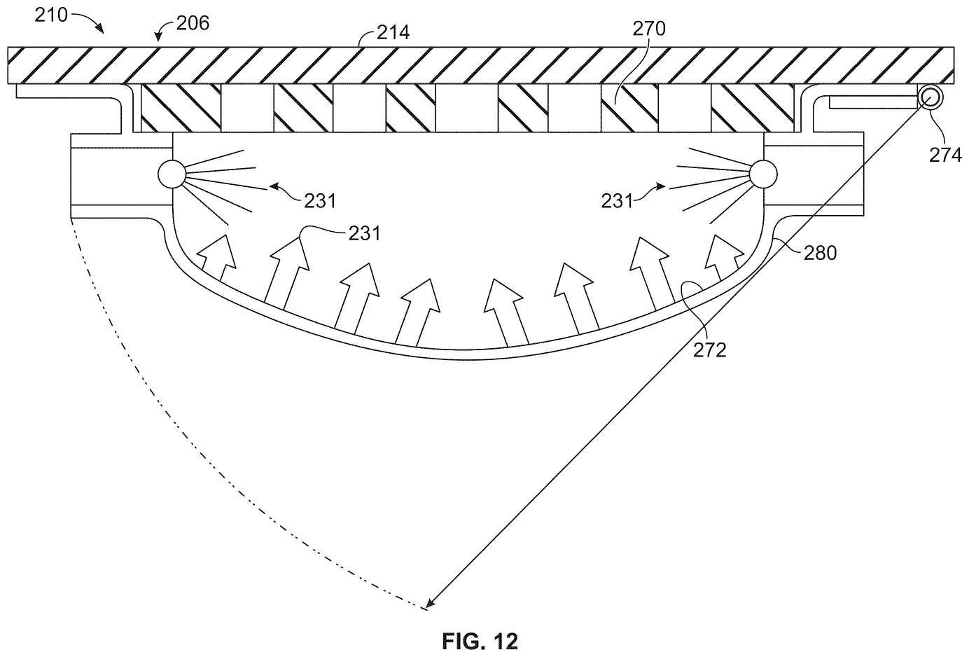

FIG. 10 illustrates a simplified lateral view of a system 210, according to an example of the present disclosure. FIG. 11 illustrates a simplified top view of an interchangeable graphic disk 270. FIG. 12 illustrates a simplified lateral view of a system 210, according to an example of the present disclosure. Referring to FIGS. 9-12, the system 210 includes a frame 280, which retains the reflective dome 272 and the lighting assembly 212. An insert, such as the disk 270. is removably secured to the countertop 206, such as within a reciprocal channel 281 formed in the frame 280. The frame 280 is pivotally coupled to the countertop 206 through the hinge 274. A latch or similar type of retention device on the frame 280 retains the disk 270 within the assembly.

The reflective dome 272 in the closed position (as shown in FIGS. 10 and 12) is underneath the disk 270. The lighting assembly 212 inwardly emits the light 231 toward the reflective dome 272. The emitted light 231 reflects upwardly from the reflective dome 272 into and through the disk 270, and the translucent material 214 of the countertop, thereby providing the lighting effects (as caused by the disk 270 and optionally a stepped portion and/or a tapered portion of the countertop 206). Optionally, the frame 280 may not retain the disk 270, and the lighting effects can be provided by tapered and/or stepped portions of the countertop 206 (such as shown in FIGS. 4 and 5).

Referring to FIGS. 1-12, examples of the present disclosure provide systems, which include a surface, such as a countertop, having one or more translucent materials. The systems are configured to control a luminous intensity, and provide lighting effects through the translucent material(s). The systems can be used in a lavatory of a commercial aircraft. The systems include a lighting assembly, such as a backlight assembly of one or more LEDs.

Further, the disclosure comprises embodiments according to the following clauses:

Clause 1. A system configured for an internal cabin of a vehicle, the system comprising:
a surface including one or more translucent materials having one or both of a variable thickness, or one or more channels configured to receive one or more inserts; and
a lighting assembly configured to illuminate the surface.

Clause 2. The system of Clause 1, wherein the surface is a countertop.

Clause 3. The system of Clause 2, wherein the countertop is within a lavatory.

Clause 4. The system of any of Clauses 1-3, wherein the variable thickness includes a stepped portion.

Clause 5. The system of Clause 4, wherein the stepped portion comprises:
a first section having a first thickness;
a second section having a second thickness which is less than the first thickness; and
a third section having a third thickness which is less than the first thickness and the second thickness.

Clause 6. The system of any of Clauses 1-5, wherein the variable thickness includes a tapered portion.

Clause 7. The system of any of Clauses 1-3, wherein the variable thickness includes a stepped portion and a tapered portion.

Clause 8. The system of any of Clauses 1-7, wherein the one or more translucent materials include multiple layers.

Clause 9. The system of any of Clauses 1-3, 7. and 8, wherein the surface comprises the variable thickness and the one or more channels configured to receive the one or more inserts.

Clause 10. The system of Clause 9, wherein the variable thickness includes a stepped portion and a tapered portion.

Clause 11. The system of any of Clauses 1-10, further comprising:
a frame;
a mirrored reflective dome coupled to the frame, wherein the lighting assembly is coupled to the frame, and wherein the lighting assembly is configured to emit light onto the mirrored reflective dome;
wherein the one or more inserts comprise an interchangeable disk coupled to the frame; and
a hinge coupled to the frame, wherein the hinge is configured to pivot to allow the frame to open and close.

Clause 12. The system of Clause 11, wherein the lighting assembly comprises a plurality of light emitting diodes arranged in a circle and pointing inward.

Clause 13. A vehicle comprising:
an internal cabin; and
a system including:
   a surface including one or more translucent materials having one or both of a variable thickness, or one or more channels configured to receive one or more inserts; and
   a lighting assembly configured to illuminate the surface.

Clause 14. The vehicle of Clause 13, wherein the surface is a countertop within a lavatory.

Clause 15. The vehicle of Clauses 13 or 14, wherein the variable thickness includes a stepped portion.

Clause 16. The vehicle of any of Clauses 13-15, wherein the variable thickness includes a tapered portion.

Clause 17. The vehicle of any of Clauses 13-16, wherein the one or more translucent materials include multiple layers.

Clause 18. The vehicle of any of Clauses 13-17, wherein the surface comprises the variable thickness and the one or more channels configured to receive the one or more inserts.

Clause 19. The vehicle of any of Clauses 13-18, wherein the system further comprises:
a frame;
a mirrored reflective dome coupled to the frame, wherein the lighting assembly is coupled to the frame, wherein the lighting assembly comprises a plurality of light emitting diodes arranged in a circle and pointing inward, and wherein the lighting assembly is configured to emit light onto the mirrored reflective dome;
wherein the one or more inserts comprise an interchangeable disk coupled to the frame; and
a hinge coupled to the frame, wherein the hinge is configured to pivot to allow the frame to open and close.

Clause 20. A method for an internal cabin of a vehicle, the method comprising:
illuminating, by a lighting assembly, a surface of a countertop of a lavatory within the internal cabin, wherein the surface includes one or more translucent materials having one or both of a variable thickness, or one or more channels configured to receive one or more inserts.

As described herein, examples of the present disclosure provide systems and methods for providing illuminated effects in relation to a surface, such as of a countertop of a lavatory within an internal cabin of a vehicle.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A system configured for an internal cabin of a vehicle, the system comprising:
a surface including one or more translucent materials having one or more channels configured to receive one or more inserts;
a lighting assembly configured to illuminate the surface;
a frame;
a mirrored reflective dome coupled to the frame, wherein the lighting assembly is coupled to the frame, and wherein the lighting assembly is configured to emit light onto the mirrored reflective dome;
wherein the one or more inserts comprise an interchangeable disk coupled to the frame; and
a hinge coupled to the frame, wherein the hinge is configured to pivot to allow the frame to open and close.

2. The system of claim 1, wherein the surface is a countertop.

3. The system of claim 2, wherein the countertop is within a lavatory.

4. The system of claim 23, wherein the variable thickness includes a stepped portion.

5. The system of claim 4, wherein the stepped portion comprises:
a first section having a first thickness;
a second section having a second thickness which is less than the first thickness; and
a third section having a third thickness which is less than the first thickness and the second thickness.

6. The system of claim 23, wherein the variable thickness includes a tapered portion.

7. The system of claim 23, wherein the variable thickness includes a stepped portion and a tapered portion.

8. The system of claim 1, wherein the one or more translucent materials include multiple layers.

9. (canceled)

10. (canceled)

11. (canceled)

12. The system of claim 1, wherein the lighting assembly comprises a plurality of light emitting diodes arranged in a circle and pointing inward.

13. A vehicle comprising:
an internal cabin; and
a system including:
a surface including one or more translucent materials having one or more channels configured to receive one or more inserts;
a lighting assembly configured to illuminate the surface;
a frame;
a mirrored reflective dome coupled to the frame, wherein the lighting assembly is coupled to the frame, wherein the lighting assembly is configured to emit light onto the mirrored reflective dome;
wherein the one or more inserts comprise an interchangeable disk coupled to the frame; and
a hinge coupled to the frame, wherein the hinge is configured to pivot to allow the frame to open and close.

14. The vehicle of claim 13, wherein the surface is a countertop within a lavatory.

15. The vehicle of claim 25, wherein the variable thickness includes a stepped portion.

16. The vehicle of claim 25, wherein the variable thickness includes a tapered portion.

17. The vehicle of claim 13, wherein the one or more translucent materials include multiple layers.

18. (canceled)

19. (canceled)

20. A method for an internal cabin of a vehicle, the method comprising:
illuminating, by a lighting assembly coupled to a frame, a surface of a countertop of a lavatory within the internal cabin, wherein the surface includes one or more translucent materials having one or more channels configured to receive one or more inserts including an interchangeable disk coupled to the frame, wherein a mirrored reflective dome is coupled to the frame, wherein the lighting assembly is configured to emit light onto the mirrored reflective dome, wherein a hinge is coupled to the frame, and wherein the hinge is configured to pivot to allow the frame to open and close.

21. The method of claim 20, wherein the one or more translucent materials also have a variable thickness.

22. The method of claim 21, wherein the lighting assembly comprises a plurality of light emitting diodes arranged in a circle and pointing inward.

23. The system of claim 1, wherein the one or more translucent materials also have a variable thickness.

24. The vehicle of claim 13, wherein the lighting assembly comprises a plurality of light emitting diodes arranged in a circle and pointing inward.

25. The vehicle of claim 13, wherein the one or more translucent materials also have a variable thickness.
